(19) United States
(12) Patent Application Publication
(10) Pub. No.: US 2021/0138337 A1
(43) Pub. Date: May 13, 2021

(54) Signa Es Alias Adversus 2

(71) Applicant: Arnes Becirovic, Grand Rapids, MI (US)

(72) Inventor: Arnes Becirovic, Grand Rapids, MI (US)

(21) Appl. No.: 16/679,243

(22) Filed: Nov. 10, 2019

(51) Int. Cl. A63F 13/00

(52) U.S. Cl. CPC A63F 13/00

(57) ABSTRACT

The Present invention is directed to a prototype technique and power mechanism for virtual reality data stimulation. Whereby a consumer may operate a technical system of One hundred and Fifty three playable characters wherein the C++ Programming language and technical software game engine technology allow for internal design, level creation and computer Programming data transformation within a binary computer server. A slight Sequence between software licensing data transformation and engineering a kinetic theory software blueprint is held within the python scripting and data terminal source code. A System of a limitless extensibility. An engineered computer software apparatus, comprising of a manipulated dimension of video game characters and space terminology. Prototyping architecture code and data server code allow for multiple representations of the binary circuit towards the consumer.

In the domestic free market distribution channel, I am seeking substantial protection for the ability to manufacture a Hip hop fighting game that contains the one hundred and fifty three characters from my elements of specification abstract claim. The apparatus contains the preferred protection of the final manufactured intrinsic software prototype invention. No individual may use an identical technological process or the future pending trademark “Signa Es”, otherwise they infringe upon the first inventor to file distribution system. In a first-to-file system, the right to the grant of a patent for a given invention lies with the first person to file a patent application for protection of that invention, regardless of the date of actual invention. I am protecting the substantial technological manufacturing background behind my Signa es Alias Adversus 2 video game Invention. Wherein the improvement comprises of the Character list being augmented from sixty seven characters to one hundred Fifty three characters, from Def jam fight for new York 2004 to Signa ES Alias Adversus 2 2021. I prefer to protect the intellectual property rights inside the Nonprovisional utility patent Signa es Alias Adversus 2. A System of cooperating apparatus, an apparatus comprising of a video game system of Characters (FIGS. 2-4)

### 37 CFR 1.71 DETAILED DESCRIPTIONS AND SPECIFICATION OF THE INVENTION

Signa Es Alias Adversus 2 is a Nonprovisional Utility patent Software Blueprint Created by Ames Becirovic.

Signa Es Alias Adversus 2 is a Hiphop fighting Game that features 153 Characters, twenty three lifestyle models and forty nine playable fighting Arenas on seven continents.

The Gameplay is a one versus one fighting Mode. The Story mode takes place on seven continents, and the game's story mode follows the narrative of an unknown player-created fighter Nes Jordan, who is fighting his way through the hiphop mainstream and underground. Winning matches' rewards the player with cash, which can be used in shops to buy clothes which include famous clothes lines such as Nike, Calvin Klein, Air Jordan, and the rappersan even create his own clothing line brand. As well as clothes, the fighter can get haircuts, tattoos, and jewelry as Development points. These points can be used at the local fitness club, run by to increase the character's skills, or to purchase and set up new Moves and increase one of the chosen fighting styles that the player has versus the competition.

Winning matches also unlocks clubs and the fighters defeated, as well as their finishing move, and often the jewelry they may wear. The fighters may be used in Battle Mode, while their moves and jewelry may be purchased and used by the player later in the game. There are lifestyle models who judge each and every fight inside the game. The player is led through a story mode where he figures out the mysteries of hiphop music all the way.

The Video game will be developed with Unreal Engine 4 by Epic games C++ Software. The Final Prototype with be Sold to a Video game Publisher with an End User Licensing Agreement Set to hit the open market in Xbox or PlayStation 4 Format. I will sell the Final prototype with 4 business Contracts. These contracts are Assignment of Rights patent issued, Assignment of Intellectual property rights, Intellectual property assignment agreement and a nondisclosure agreement.

### 17 U.S. Code § 117. Limitations on Exclusive Rights: Computer Programs

Unreal Engine Grants me a License to Use their Software in order to develop my Video game Prototype. Epic games Receives 5% Royalty after $3000.00 for every video game Developed per calendar year. I will develop the Final Prototype along with a Feature list.

The Final Video game has a Settings mode, 50 Gameplay Features, 5 Tool Features, 10 System Features and 5 Process Features along with a story mode. My Target Audience Is a Mature Audience, Hiphop Fanatics and the Schedule must be created before the budget is estimated.

### BACKGROUND OF THE INVENTION/UNITY OF INVENTION

### The Field of the Invention

The Invention Signa Es Alias Adversus 2 Generally relates to the Def Jam Fight for New York Concept, developed by Aki Corporation, published by EA Games which was released on Sep. 21, 2004. Def Jam Fight for New York features 67 playable characters, including real-life hip hop artists signed to Def Jam at the time, as well as original characters. Signa Es alias Adversus 2 Features 153 Characters Signed to various labels in hip hop music at the time it was created.

### Background of the Prior Art

The Professional Art was created by me and the Art will be used inside the final prototype if possible. Character designers need to have technical skills in both computer-design programs and visual art. Some animation and coding skills don't hurt, but they're not as necessary to the profession. When it comes to visual art, I have a solid grasp of anatomy along with a creative imagination. But in order for characters to move around and function in the game world, they need to have physically sound proportions. Adobe illustrator and Photoshop along with Pixlr photo editor must be mastered in order to do this. A Basic grasp of Human Psychology Behavior traits along with Character Design has to be incorporated in order to create all of the characters inside the Prototype. I have to create all of the characters along with all of the Fighting arenas using Unreal Engine Software. Unreal Engine 4 should give me the Ability to create the Software along with Visual Scripting and Python Scripting. Unreal Engine provides the highest-quality solution for creating virtual reality (VR), augmented reality (AR), and mixed reality (MR) experiences. Unreal Engines LOD system will let me Create large open-world environments with the Landscape system. A powerful LOD system and efficient memory use make massive-scale landscapes achievable. Rendering and Graphics along with Chaos Destruction allow me to Create Artificial Intelligence inside my game. Multiple systems working together inside the software such as Behavior Trees, Environmental query system, Ai perception and AI Debugging allow me to create the characters that I need to make the Prototype a Reality. Unreal Engine Features 32 Tools and Systems for Video game Creation that I will use to create my Final Prototype patent software. Unreal Engine allows me to ship my final project without obstruction

### NO CROSS REFERENCE TO RELATED APPLICATIONS

### Brief Summary of the Invention/Brief Description or Drawings

### 608.01(d) Brief Summary of Invention/37CFR 1.73

The Nature of Signa Es Alias Adversus 2—Prototype Software Utility patent with a Gameplay Layout Designed by Unreal Engine 4/Epic Games

Operation/Civil law—The final prototype is a form of intellectual property that gives me the owner the legal right to exclude others from making, using, selling and importing an invention for a limited period of years. In exchange for publishing and enabling public disclosure of the final prototype, I will sell the final prototype to an End User publishing company using an End user Licensing Agreement along with 4 pieces of intellectual property contract. These pieces of contract are Assignment of Rights patent issued, Assignment of Intellectual property rights, Intellectual property assignment agreement and a nondisclosure agreement.

Purpose of the invention—The purpose of Signa Es Alias Adversus 2 is to entertain the Mainstream and Hiphop underground music fans with a Video game stimulus threshold on the PlayStation 4 and Xbox. Nothing will give these fans more of a rush then to able to fight with their favorite hiphop artists and music Producers on the television screen.

1. A method and system of virtual reality data Stimulation, directly containing an abstract reality of entertainment within a virtual reality data circuit comprising the programmed steps of:
(a) A manipulated data System of one hundred and fifty three playable Characters using a unified modeling language engineering platform. Containing certain statutory rights, that is given to the creators and their assigns, including the right to control the distribution of their creative works.
(b) The method for engineering the system of claim 1, further comprising the steps of using C++ Programming language towards the binary prototype.
(c) The method for Technical Software Engineering the product of claim 1, further comprising the step of refactoring the code.
(d) The method of Game Engine software constructing the system of claim 1, further comprising the steps of LOD and Chaos destruction towards the End product.
(e) The method of Design, Level creation and computer Programming data transformation of claim 1, further comprising the step of a final prototype.
(f) Original Sound recordings that contain certain musical composition that comes from certain compact disc, vinyl disk, open reel tape and cassette tapes.
(g) Restricting general public access to the intellectual property product-barring the content provider from pretending to be said consumer.
(h) The method for the distribution of the prototype of claim 1, further comprising the step of entering into a licensing agreement with the assignee of the intellectual property rights associated with said digital product.
